(19) United States
(12) Patent Application Publication
(10) Pub. No.: US 2015/0227772 A1
(43) Pub. Date: Aug. 13, 2015

(54) DETECTION AND DECODING METHOD

(71) Applicant: COOPERATIVE VISION SYSTEMS PTY LTD, Queensland (AU)

(72) Inventors: Thomas Christopher Landgrebe, Pymble (AU); Andre Paul Le Vieux, Aspley (AU)

(73) Assignee: Cooperative Vision Systems PTY Ltd., Queensland (AU)

(21) Appl. No.: 14/428,375

(22) PCT Filed: Oct. 17, 2013
(86) PCT No.: PCT/AU2013/001204

§ 371 Date: Mar. 16, 2015

(30) Foreign Application Priority Data
Oct. 29, 2012 (AU) 2012904757

(51) Int. Cl. G06K 7/14; G06K 19/06; G06K 9/20; G06K 9/46; G06K 9/56

(52) U.S. Cl. CPC G06K 7/1443; G06K 9/4652; G06K 9/56; G06K 9/2054; G06K 19/06037

(57) ABSTRACT

An electronic method of detecting a visual object in an image of a scene comprises sampling the image at sampling points with a sampling template defining a fixed set of image detection offsets relative to any sampling point at which the image is sampled, each of the set of image detection offsets being related to another one of the image detection offsets, obtaining at least one colour value for each image detection offset relative to any sampling point, forming a set of data values by, for each image detection offset, comparing each at least one colour value with a corresponding colour value of the related image detection offset to obtain a data value, and upon a set of data values obtained for a sample point satisfying a detection condition for the visual object, determining that the visual object has been located.

### FIELD

The present invention relates to detecting and/or decoding an encoded visual object in an image of a scene as well as to related detection and/or decoding systems, articles incorporating particular visual objects and methods for forming visual objects.

### BACKGROUND

A large variety of types of optically machine-readable representations of data have been developed. The most widely known are barcodes which represent data by varying the width and spacing of a number of parallel lines. Such barcodes are designed to be read in relatively controlled conditions by barcode readers that can be brought into close proximity with the barcode.

When there is a need to read an optically machine-readable representation of data at a greater distance, a number of challenges arise including:
(i) locating the optically machine-representation of data amongst other objects that are in the field of view of reading device;
(ii) potential variations in the position of the optically machine-representation of data relative to the reading device;
(iii) potential variations in lighting conditions;
(iv) keeping the size of the optically machine-readable representation of data reasonable for the application; and
(v) in some cases, motion of the optically machine readable representation which may result in blurring of details of the representation.

There is a need for additional techniques that address one or more of the above challenges.

### SUMMARY

In a first aspect, the invention provides an electronic method of detecting a visual object in an image of a scene, the method comprising:
sampling the image at sampling points with a sampling template defining a fixed set of image detection offsets relative to any sampling point at which the image is sampled, each of the set of image detection offsets being related to another one of the image detection offsets;
obtaining at least one colour value for each image detection offset relative to any sampling point;
forming a set of data values by, for each image detection offset, comparing each at least one colour value with a corresponding colour value of the related image detection offset to obtain a data value; and
upon a set of data values obtained for a sample point satisfying a detection condition for the visual object, determining that the visual object has been located.

In an embodiment, the image detection offsets are spaced relative to one another in order to be able to detect an object comprising a known number of angular segments, each segment comprising a pair of radially extending sides that extend to a common radial extent relative to a common central point.

In an embodiment, the method comprises converting the image to a colour space from which the colour values are to be obtained before sampling the image.

In an embodiment, the colour space is L*a*b* space.

In an embodiment, the method comprises converting sampled portions of the image to a colour space before comparing colour values.

In an embodiment, the method comprises comparing three colour values for each image detection offset.

In an embodiment, there is a set of possible data values that can be determined from each comparison.

In an embodiment, there are three possible data values that can be determined from each comparison.

In an embodiment, comparing each colour value comprises calculating a difference between the one colour value and the corresponding colour value of the related image.

In an embodiment, the method comprises allocating a data value to the calculated difference by applying at least one threshold to the calculated difference.

In a second aspect, the invention provides an electronic method of extracting a data string from a visual object in an image of a scene, the method comprising:
sampling the image at a sampling point corresponding to the visual object with a sampling template defining a fixed set of image decoding offsets relative to any sampling point at which the image is sampled, each of the set of image decoding offsets being related to another one of the image decoding offsets;
obtaining at least one colour value for each image decoding offset relative to any sampling point;
obtaining a set of data values by, for each image decoding offset, comparing each at least one colour value with a corresponding colour value of the related image decoding offset to obtain a data value; and
forming a data string from the set of obtained data values.

In an embodiment, the image decoding offsets are spaced relative to one another in order to be able to decode an object comprising a known number of angular segments, each segment comprising a pair of radially extending sides that extend to a common radial extent relative to a common central point.

In an embodiment, the method comprises determining the sample point by sampling the image at sampling points with a sampling template defining a fixed set of image detection offsets relative to any sampling point at which the image is sampled, each of the set of image detection offsets being related to another one of the image detection offsets;
obtaining at least one colour value for each image detection offset;
forming a set of data values by, for each image detection offset, comparing each at least one colour value with a corresponding colour value of the related image detection offset to obtain a data value; and
upon a set of data values, obtained for a sample point satisfying a detection condition determining that a sample point has been located for decoding the object.

In an embodiment, there is a single sampling template comprising both the image detection offsets and the image decoding offsets whereby a single sampling process is used to obtain data values for detection and decoding.

In a third aspect, the invention provides for detecting a visual object in an image of a scene, the system comprising:
an image sampler arranged to sample the image at sampling points with a sampling template defining a fixed set of image detection offsets relative to any sampling point at which the image is sampled, each of the set of image detection offsets being related to another one of the image detection offsets;
a data set extractor arranged to form a set of data values by, for each image detection offset, comparing at least one colour value obtained at the image detection offset with a corresponding colour value obtained at the related image detection offset to obtain a data value; and
a detection determiner arranged to determine that the visual object has been located upon a set of data values, obtained for a sample point satisfying a detection condition.

In a fourth aspect, the invention provides system for extracting a data string from a visual object in an image of a scene, the system comprising:
an image sampler for sampling the image at a sampling point corresponding to the visual object with a sampling template defining a fixed set of image decoding offsets relative to any sampling point at which the image is sampled, each of the set of image decoding offsets being related to another one of the image decoding offsets;
an image decoder arranged to process at least one colour value for each image decoding offset to obtain a set of data values by, for each image decoding offset, comparing each at least one colour value with a corresponding colour value of the related image decoding offset to obtain a data value, and form a data string from the set of obtained data values.

In an embodiment the image sampler is arranged to sample the image at sampling points with a sampling template defining a fixed set of image detection offsets relative to any sampling point at which the image is sampled, each of the set of image detection offsets being related to another one of the image detection offsets, and the image decoder forms a set of data values by, for each image detection offset, comparing each at least one colour value of the image detection offset with a corresponding colour value of the related image detection offset to obtain a data value, and, the system comprises a sample point determiner arranged to determine a sample point has been located for decoding the object upon a set of data values satisfying a detection condition.

In a fifth aspect, the invention provides an electronic method of detecting a visual object in an image of a scene, the method comprising:
sampling the image at sampling points with a sampling template defining a fixed set of image detection offsets relative to any sampling point at which the image is sampled; and
determining the location of at least part of the visual object by finding a plurality of sampling positions that correspond to local maximums in the difference between colour values for the image detection offsets.

In an embodiment, the method comprises determining a data value from the at least one colour value that corresponds to the local maximum in difference between colour values.

In an embodiment, the method comprises locating all connected locations in the image having the same data value.

In an embodiment, the method comprises converting the image to a colour space from which the colour values are to be obtained before sampling the image.

In an embodiment, the colour space is L*a*b* space.

In a sixth aspect, the invention provides a system for detecting a visual object in an image of a scene, the method comprising:
an image sampler arranged to sample the image at sampling points with a sampling template defining a fixed set of image detection offsets relative to any sampling point at which the image is sampled; and
a detection determiner arranged to determine the location of at least part of the visual object by finding a plurality of sampling positions that correspond to local maximums in the difference between colour values for the image detection offsets.

In a seventh aspect, the invention provides an electronic method of forming a visual object that can be applied to an article to encode a data string, the method comprising:
obtaining a data string to be encoded;
forming an arrangement of a plurality of angular segments;
obtaining a set of spatial relationships to be used in determining the data string, the set of spatial relationships corresponding to the relative positions of at least some of the plurality of angular segments; and
selecting a set of colours for the plurality of angular segments based on the set of spatial relationships such that, for each spatial relationship, differences in colour values between positions defined by the respective spatial relationship encode a portion of the data string, whereby the entire data string can be assembled from the respective portions of the data string.

In an embodiment, the method comprises selecting the colour of at least one segment based on a colour of at least one other segment.

In an embodiment, the method comprises selecting the colour of at least one segment based on a background colour.

In an embodiment, each offset defines a spatial relationship between a pair of the angular segments.

In an embodiment, the set of spatial relationships have an associated evaluation order and the data string is assembled by concatenating the portions of the data string in the evaluation order.

In an eighth aspect, the invention provides a system for forming a visual object encoding a data string, the system comprising a processor arranged to process a data string to select a set of colours for respective one of a plurality of segments of a visual object based on a set of spatial relationships, each colour selected such that, for each spatial relationship, differences in colour values between positions defined by the respective spatial relationship encode a portion of the data string, whereby the entire data string can be assembled from the respective portions of the data string.

In a ninth aspect, the invention provides an article comprising a visual object that encodes a data string,
the object comprising a plurality of angular segments,
each segment comprising a colour selected to encode a portion of the data string based on a set of spatial relationships such that, for each spatial relationship, differences in colour values obtained by image processing a part of an image of the object corresponding to the positions defined by the respective spatial relationship encode a portion of the data string, whereby the entire data string can be assembled from respective portions of the data string.

In an embodiment, each segment comprising a pair of radially extending sides that extend to a common radial extent relative to a common central point to thereby allow the object to be detected during image processing of images of different spatial scales that contain the object.

In an embodiment, for at least one segment, the other colour value is obtained from a related segment of the object.

In an embodiment, the related segment is related by being a neighbouring segment.

In an embodiment, for at least one segment, the other colour value is obtained from a background colour.

In an embodiment, the background colour is a colour of the article where the object is positioned on the article.

In an embodiment, the background colour is a colour of the object at a position not having a segment.

In an embodiment, the colour chosen for each segment enables a plurality of colour values to be compared for each segment to obtain a plurality of portions of the data string.

In an embodiment, the object is embedded in the article.

In an embodiment, the object is attached to the article.

The invention also provides computer program code which when executed implements one or more of the above methods.

### BRIEF DESCRIPTION OF DRAWINGS

Embodiments of the invention will now be described with reference to the accompanying drawings in which:

FIG. 1 is a schematic diagram indicating how a visual object may be captured in an image of a scene;

FIG. 2 is a block diagram of a system for identifying and decoding objects of an embodiment;

FIGS. 3A to 3C show three examples of visual objects;

FIG. 4 illustrates the effect of channel separation;

FIG. 5 is a flow chart illustrating both visual object identification and decoding;

FIG. 6 is a block diagram of a system for generating a visual object;

FIG. 7 illustrates the difference between visual objects of the embodiments and QR-codes;

FIG. 8 is a flow chart of a method for generating a visual object; and

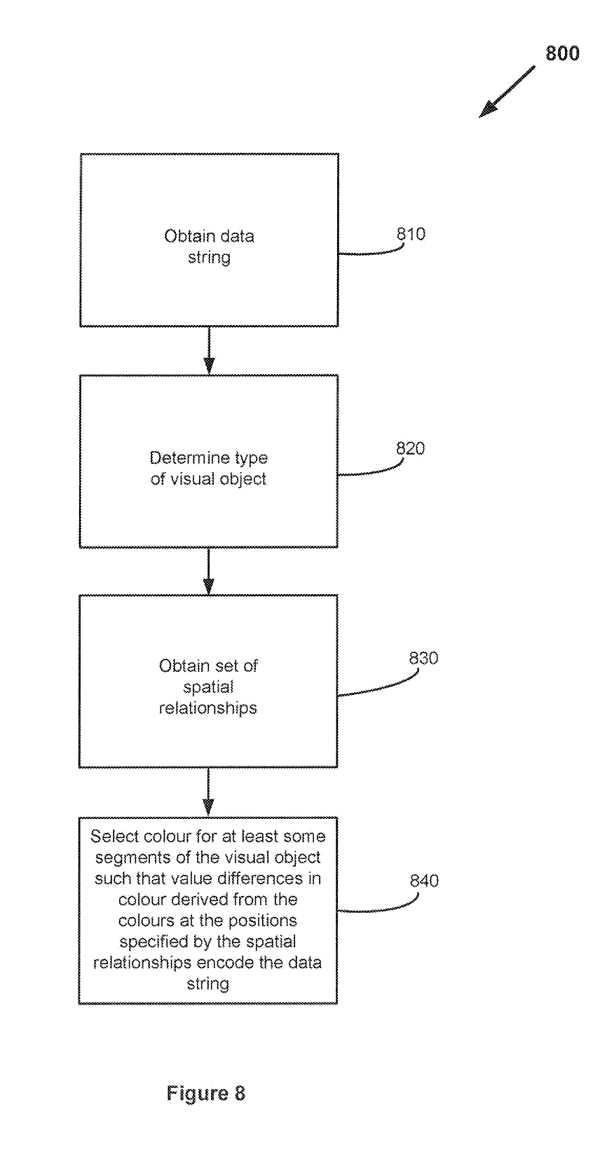

FIG. 9 is a schematic diagram of an embodiment where coded lines can be recovered from an image.

### DETAILED DESCRIPTION

Referring to the drawings, there is shown a system for detecting and/or decoding visual object in an image of a scene, articles comprising visual objects that can be detected and/or decoded, as well as a system for generating visual objects. In the embodiments, the variations between colours of segments of the visual object encode data that can be detected and/or decoded.

As will be described in further detail below, depending on the embodiment the visual object is an optically machine-readable representation of data or the visual object co-operates with the colour of an article on which it is placed to form an optically machine-readable representation of data. For example, if the visual object is placed on an article of clothing to assist in identification of workmen in an industrial environment, the colour of the article of clothing in the region where the visual object is located can provide a background colour that is used in conjunction with the colours of segments of the visual object to encode information. Persons skilled in the art will appreciate that in such an example, the visual object could be attached to the article of clothing or embedded therein by being part of the overall clothing design.

As will be described in further detail below, embodiments of the invention provide methods for detecting, identifying and tagging objects in images and video sequences based on a specific visual pattern design of the visual object. The embodiments employ a method for encoding information via relative light intensities and colour patterns that enable data to be encoded based on variations between various segments of the pattern. A particular colour pattern is used to encode a data string analogous to a serial “barcode” in which variations between different parts of the pattern are used to encode data values that can be put together to form a longer data sting.

Embodiments of the invention can provide one or more of the following characteristics:
The ability to recognise visual objects with relatively low resolution or in relatively small regions of an image, allowing for long range detection and small physical footprints for the visual objects.
Robustness pertaining to the tagging of moving objects—i.e. robust to motion-blur.
Detection in cluttered environments.
Detection across a wide range of scales.
Detection of large numbers of visual objects in an image simultaneously.
The ability to encode very large numbers of identities.
A decoding algorithm scaling linearly with the number of pixels, irrespective of the number of visual objects in a scene.

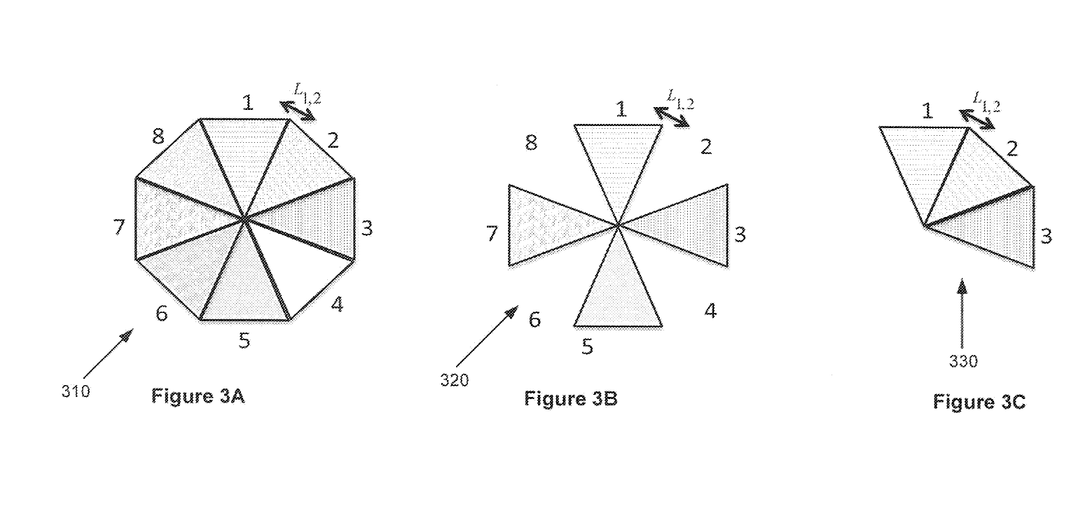

As shown in FIGS. 3A to 3B, visual objects of embodiments of the invention 310, 320, 330 employ a spatial pattern divided into angular segments. That is, the visual object is partition into angular segments that originate from the centre, and increase in area as they move outwards. While the Figures show triangular segments, other shapes may be employed for the segments, for example circular sectors provided the extremities of the sectors are at a substantially constant radial distance relative to the centre. As will be described in further detail below, employing a substantially constant radial distance for the extremities of the sectors decreases the likelihood of missed detections when seeking to detect the visual object in an image of a scene given that in embodiments of the invention the size of the visual object will depend on the scale of the image.

FIG. 3A shows a visual object 310 having eight segments labelled 1-8. The inventors have determined that eight segments can be employed to encode a significant amount of data while still allowing a relatively small visual object to be detected. However, persons skilled in the art will appreciate that more or fewer segments can be employed. FIG. 3B illustrates that an object can employ a background colour for some of the segments, in this example a single background colour replaces segments 2,4,6 and 8 of FIG. 3A. The background colour can be part of the visual object or be a colour of the article to which the visual object is attached or in which it is embedded. FIG. 3C illustrates that visual objects 330 of some embodiments need not on rely a full 360 degree circular pattern, but instead use a number of adjacent segments to define a data string. The segments need not be adjacent because the decoding technique relies on the relative position of the segments as defined by a set of offsets used in the decoding process. For example, the visual object of FIG. 3b could be employed without the background colour.

Persons skilled in the art will appreciate that other non-circular patterns of segments are possible. For example two adjacent segmented circular elements may be employed. Furthermore non-triangular segments may also be used including geometric primitives or even amorphous shapes with non-linear shared edges.

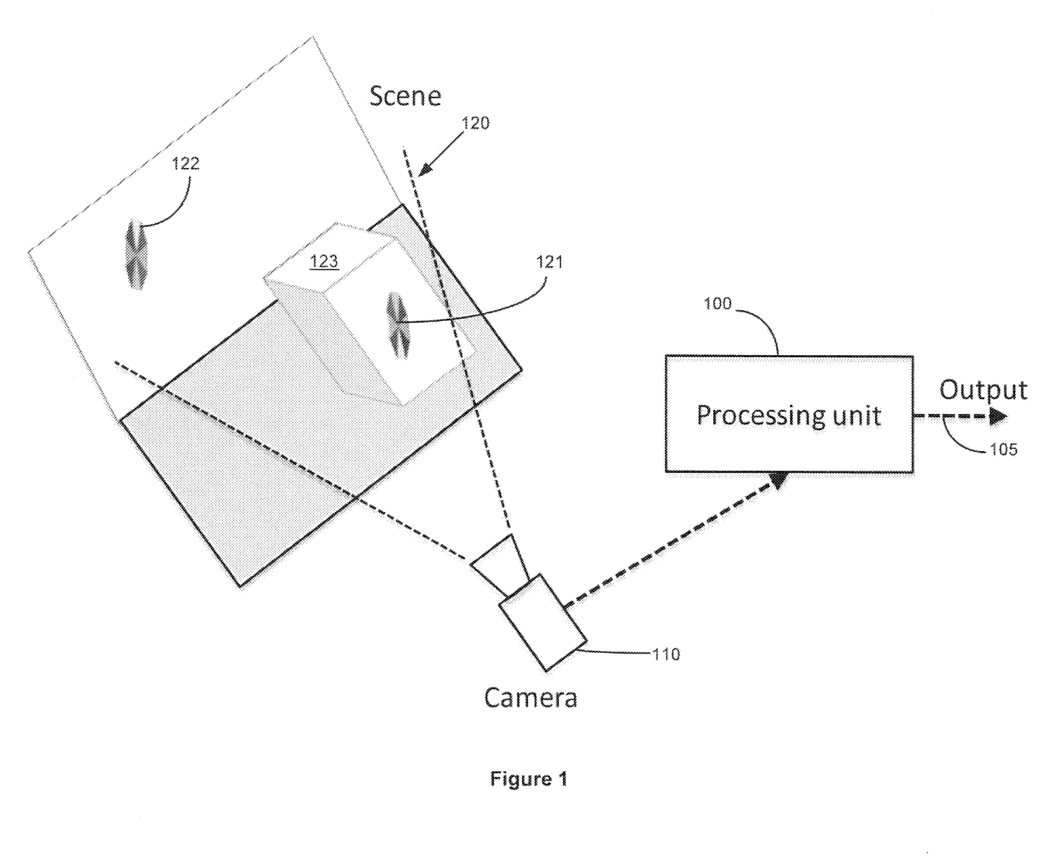

FIG. 1 shows that a camera 110 captures video images of a scene 120 containing two visual objects 121 and 122. As indicated in FIG. 1, the scene 120 may include an object 123 on which one of the visual objects 121 is placed. The object 123 could be, for example, the shirt of an employee in a factory. The output of the camera 110 is passed to a processing unit 100 arranged to generate outputs 105.

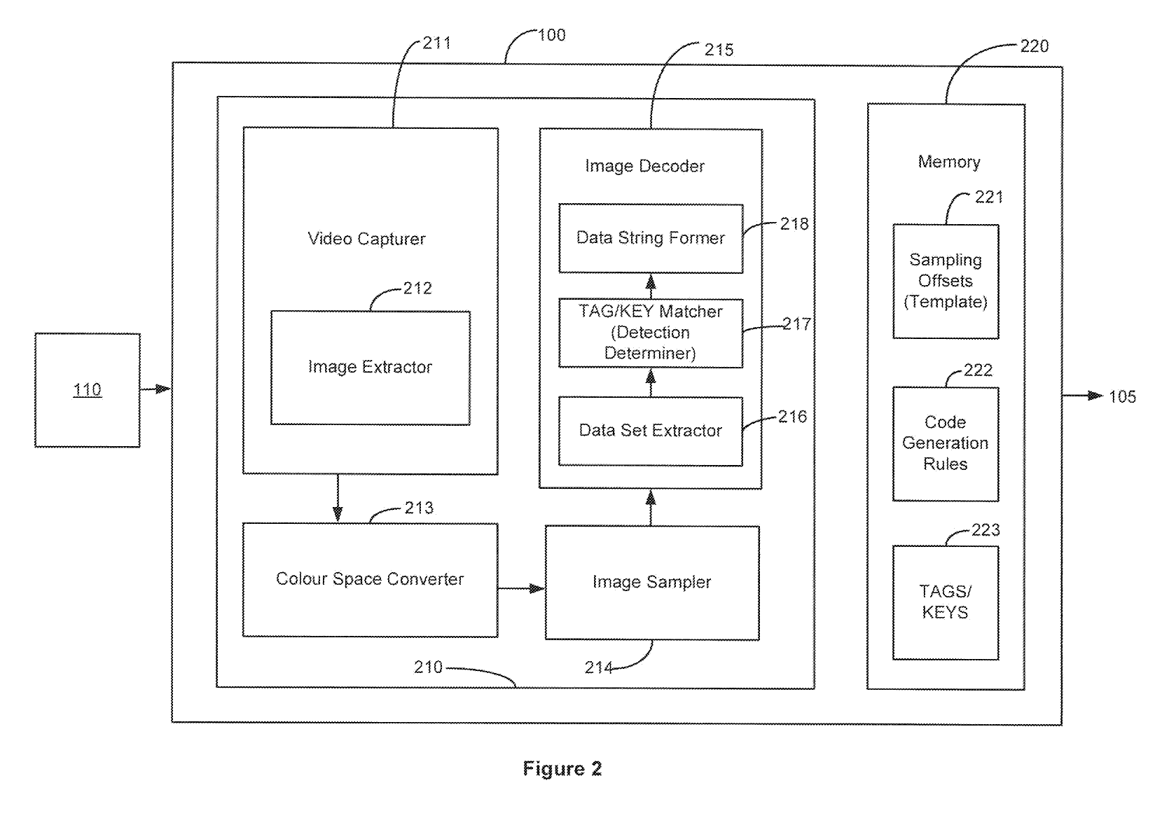

FIG. 2 is a block diagram of the processing unit 100 and one example of an embodiment. The processing unit has a processor 210 and a memory 220. The processor implements a number of modules which could also be implemented as dedicated hardware. For example, there are known hardware arrangements for capturing and storing video data and accordingly, video capturer 211 could be implemented by separate hardware. The video capturer 211 contains an image extractor 212 for extracting still images from the video stream from camera 110. For example, live video at an industrial installation. The image extractor 212 takes a frame of the image. The image extractor 212 may be arranged to extract every frame or just a sample number of frames, for example, every 10^{th} frame. The number of frames extracted will depend on factors such as the frame rate of the camera 110 and whether it is required by to track the position of any located visual object (which may also be considered to be a tag). The processing unit 100 includes a colour space converter 213 for converting the extracted image, which would typically be an RGB (colour) image, to a desired colour space such as L*a*b*. The image sampler 214 samples the image with a set of sampling offsets 221 that define a template stored in memory 220. Colour values at these sample offsets are then passed to an image decoder 215. Image decoder 215 has a number of functions. Firstly, a data set extractor 216 which extracts a data set for the offsets at the current sampling point. Image decoder 215 also has a tag and/or key matcher 217 which determines whether a visual object has been detected by determining whether it can match the extracted data set to a tag or key identity stored in memory 223. In this respect, the data set extractor 216 extracts the codes in accordance with the code generation rules 222 which define the decoding algorithm including such as which the offsets are to be compared with one another and the possible values that can be generated from each comparison (e.g. −1, 0, 1) the order in which the offsets should be evaluated. As described in further detail below, where desired, the visual object may encode a data string which may function as a unique indenifier in a manner analoguous to a bar code. In such embodiments, a data string former 218 is used to form a data string from the extracted data. In some embodiments, the data string is assembled in a defined evaluation order associated with the offsets. In other embodiments, a value of the data string can be a check bit indicating a specific position in the data string (such as the start or the end), such that the data string can be ordered based on the check bit.

As indicated above, a frame (colour image) is extracted from a video string at a fixed resolution. The frame is converted from a colour image (represented in a default 3-channel RGB or Red-Green-Blue colour space) into a CIELAB colour space, called the L*a*b* representation, where L*, a* and b* represent derived luminance and two chrominance channels respectively. Measurements are not undertaken in a raw RGB space, but rather in a derived colour space in which grey-scale intensity is modelled separately from colour variations (chromaticity). The use of a colour space reduces the impact of illumination changes and cameras with different characteristics.

The image processing unit scans each extracted reproduction and seeks to identify pixels at defined offsets that correspond to part or all of the colour pattern employed in the visual object. For example, in some embodiments, the visual object has an identifier (or “key”) formed from a predefined subset of pattern segments in order to allow the visual object to be located, and the remaining segments specify the barcode identity (a unique data string). For example, a set of visual objects may use the same identifier allowing each of them to be located using the same scanning technique but may encode different information.

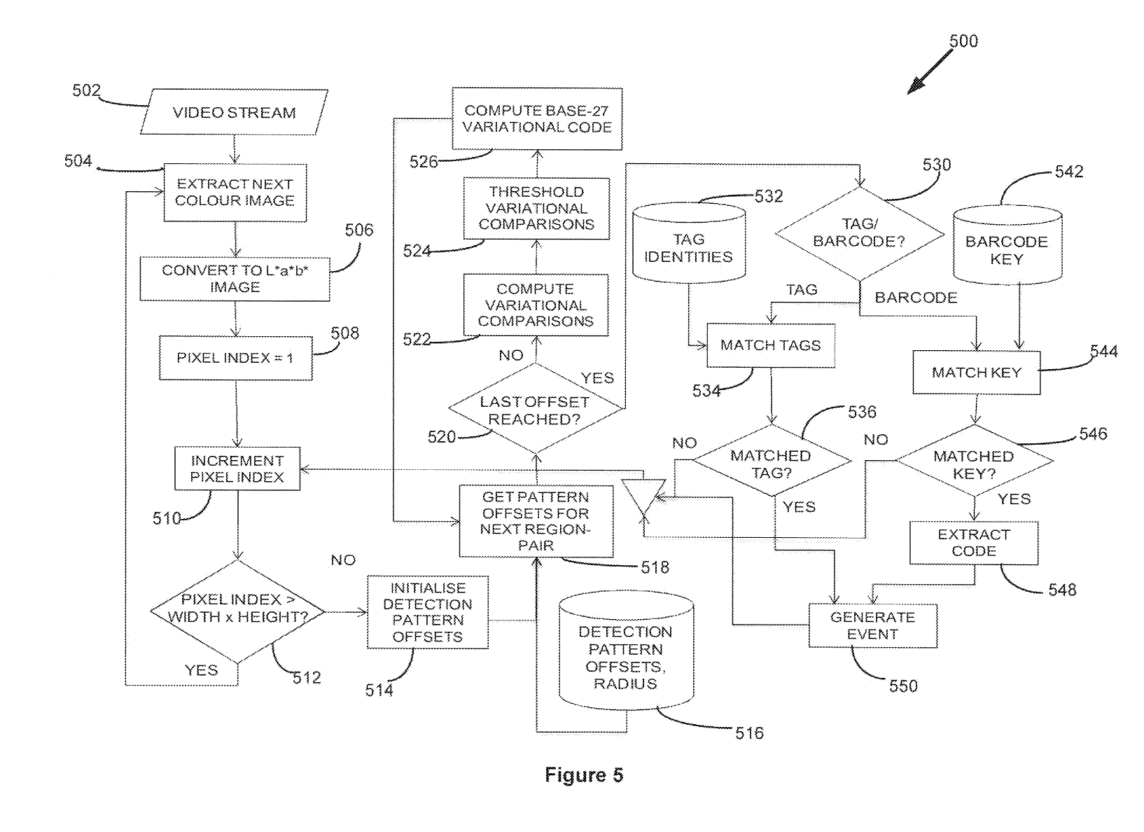

Every pixel within a frame potentially encodes part of the data string. Accordingly, a predefined detection pattern template is defined by a list of pixel offsets to be applied relative to a base position, for example an offset of a set number of pixels along the x and y axes relative to the base position. The spatial relativity of the set of offsets is arranged to detect visual objects that radially increase in area outwards relative to the base location, thus allowing fixed offsets to be used in a single pass, and consequently the tag may be detected at multiple spatial scales using a method that is linear with the number of pixels. That is, the angular separation of the offsets matches that of the segments of the visual object to be located, when an object is located, at the base position of the template proximate to the base position of the visual object. In this case each of the offsets will fall within the area of one of the segments for a large range of sizes of the segment in an image (in general, provided the size of the radius of the visual object is not smaller than the radial offset of the detection template). In this way, the template can be moved across the image in a manner analogous to a raster scan, for example on a pixel by pixel basis to sample the image at a series of sample points until one or more visual objects have been located. In this respect, while the example of FIG. 5 described below indicates sampling on pixel by pixel basis, a smaller number of sampling points may be employed in some embodiments, for example to exclude sampling points where one of the offsets falls outside the boundary of the image or by sampling at every second pixel if doing so will not risk an object being missed due to the expected size of the visual object in the image. Another example is by sampling a set of images in a video sequence stochastically. The number of samples can be varied to control the probability of missing the pattern sought.

Broadly, in one example, the detection method involves considering relative differences between pairs of regions, relative to a current base pixel location in the frame—i.e. at a sampling point.

At that sampling point, the predefined list of image detection pattern offsets is queried to extract the colour values at offsets that potentially match the first two segments. The relative differences are computed between colour values in a subset of pairs of offset locations (each offset with associated characteristics). The method involves subtracting values at the offset locations in the L*, a* and b* channels, resulting in a total of three variational comparisons.

Variational comparisons are thresholded for each channel, resulting in one of three possible outcomes, depending on whether the variational comparison is significantly positive, negative, or insignificant, as determined by channel-wise thresholds. The thresholds are determined by considering small fluctuations due to measurement noise, only allowing large variations to be chosen as significant variations. Each thresholded variational comparison per channel thus results in a data value that may take one of three values. That is, each results in a 3-valued ternary number (a base-3 number). That is each value is effectively a bit of the data string. The three channel results are combined together (in a defined order) into a single base-27 number considered to be the variational code defined between the two regions. Those skilled in the art will appreciate that other bases may be chosen by varying the number of thresholds and colour channels. The decoding algorithm is described in more detail below but in general terms, the method extracts variational codes between regions as defined by the list of offsets relative to a base pixel location. Any number of regions can be used, with typical numbers of regions that are sampled varying between 5 and 8 to optimise the trade-off between required image resolution, physical size, and detection range for a specific application.

After the first comparison, the method iterates through the list of predefined detection pattern offsets, and progressively stores the computed variational codes. That is, colour values at pairs of offset positions are compared as described above thus adding a base-27 “digit” for each pair of offsets to form the data string.

Once variational codes pertaining to all detection pattern offsets have been computed, the data string is then matched and/or further decoded. Herein visual objects can either act as a “tag” or a “barcode”.

In the tag case, the data string is directly matched to predefined data string, resulting in either a positive or negative result if a match condition is satisfied. In some embodiments, the match need not be exact, for example, if the consequence of an incorrect match is not problematic. For example, the tag data string may be correlated to a set of possible data strings and be determined to be a match if it returns a significantly higher match score to one of the possible data strings. This is beneficial for applications involving degraded lighting conditions or inferior imaging devices. A positive detection can also be determined by filtering consistently high match scores though time within a constrained spatial region in a plurality of images related in time.

In the barcode case, a predefined “key” sequence in a predefined position is used for matching, thus extracting those variational codes only. In the case of a positive match, a set of variational codes in the remaining regions is extracted. In such an embodiment, the sampling template may be considered to have both image detection offsets and image decoding offsets that are used for decoding. In some embodiments, the key may form part of the barcode. For example, in some embodiments, different keys may correspond to different classes of items such that the “key” part of the barcode distinguishes between the different classes of items. Further, if the visual object is already known to be present, the entirety of the visual object can be used for a barcode.

FIG. 5 is a process flowchart which summarises the above method. The input to the method 500 is a video stream 502. The method involves extracting the next colour image from the video stream 505 and converting it to an L*a*b*image 506. Then from a starting sampling point 508 in the form of a defined pixel index a sampling process begins. (In subsequent iterations the pixel index is incremented 510 provided not all pixels have been scanned 512). The method involves initialising the detection pattern offset 514 based on the detection pattern offsets stored in memory 516. The method 500 then involves iterating through each of the offsets for detecting a code. This involves, for each pattern, computing the variational comparisons 522 and comparing them to a threshold 524 in order to generate a base 27 variational code 526. After the last offset is reached 520, the method involves comparing the extracted code with either a tag 534 or a key 544 depending on whether a tag/barcode recognition process has been set 530 within the processing unit 100.

For a tag comparison, the tags are matched 534 against tag identities 532 and if there is a tag match 536 an event is generated 550, e.g. an output indicating there is a match. If there is no match, the method involves incrementing the pixel index 510 to thereby continue to scan across the image to seek to locate a tag. If a tag is matched as, an event is generated 550 and in one example, the process 500 continues to try to locate further tags in the image (on the assumption there may be more than one tag in the scene). In other examples, the process may stop once a single tag is located.

In a barcode embodiment, a key is matched 544 and upon a key being matched 546 the code is extracted 548. This involves using image decoding offsets extracted from the database 516 following the same process as steps 520 to 526.

In the embodiment, each pixel location in an image involving a positive match with predefined tag identities or barcode keys is passed to an event generator. The event generator transmits data via output 105, e.g. metadata, pertaining to the detected code in one of a number of ways, including transmission as a digital message over the Internet, triggering of external hardware, annotating a graphical user interface (e.g. to bring up employee data relating to an identified employee in an industrial environment or additional information pertaining to an object tagged in a public environment), adding an entry to a database etc. In one example, the metadata contains the following information:
Identity of the detection and any extracted “bar code”.
Location of the detection in the image.
Time-stamp pertaining to the detection time.
Estimated scale at which the detection occurs.

### Decoding Algorithm

As indicated above, the decoding algorithm involves systematically processing each pixel location in a 2-dimensional colour image, and analysing variations between measurements at different offsets (according to a predefined measurement pattern) relative to a reference pixel. The approach relies entirely on a variational approach to recover predefined encoded patterns, using the consistency in the variations in intensity and chromaticity (related to differences in colour) between regions on a pattern to encode a signature. Such a methodology provides invariance between different cameras, dynamic lighting conditions, and unknown light sources. Consider a 3-colour Red-Green-Blue (R,G,B) image I_{R,G,B} with width w pixels, and height h pixels. The first step of decoding involves conversion from the original 3-band colour space to the CIELAB colour scale, in which brightness (denoted the single-band L*) is separated from a two-dimensional representation of approximately uniform colour, denoted the a* and b* channels respectively. The image is thus mapped from I_{R,G,B} to I_{L*,a*,b*}, with a normalised representation from 0.0 to 1.0 used. An arbitrary pixel at location (x, y) is denoted I_{L*,a*,b*}(x, y)=[I_{L*}(x, y), I_{a*}(x, y), I_{b*}(x, y)]. Persons skilled in the art will appreciate that other colour spaces could be used such as YCrCb or normalized representations of the RGB space.

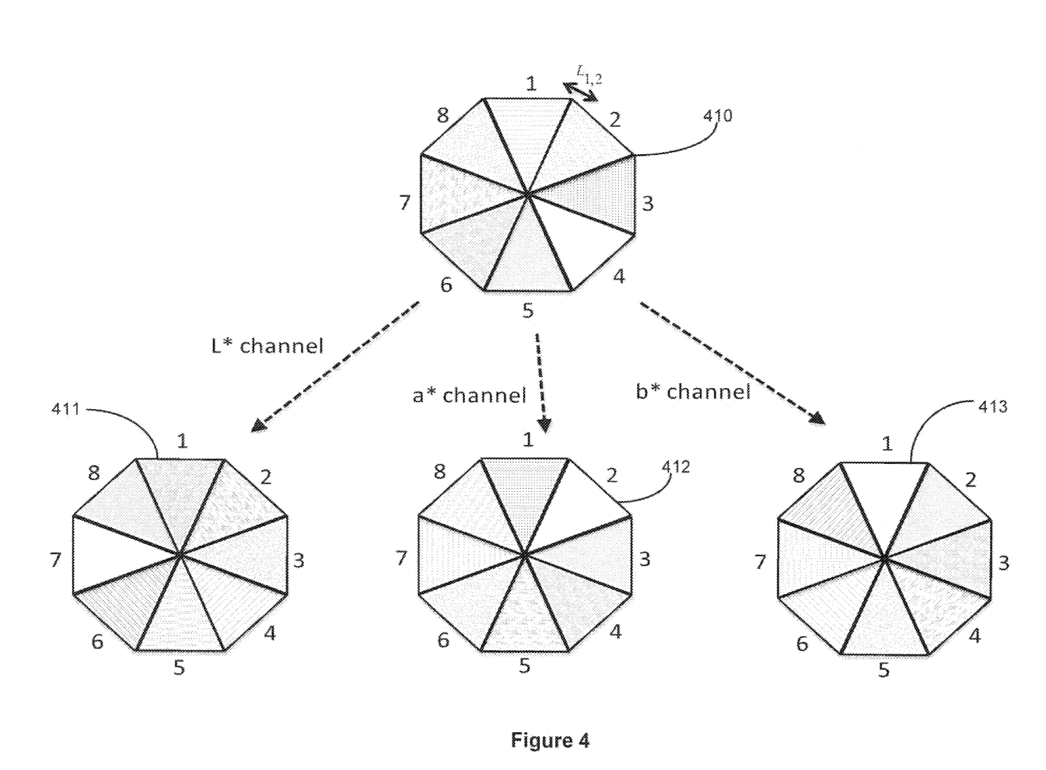

Consider the arbitrary location (x, y), 1<x≦w; 1<y≦h, and two offset specifications (xₒ_{₁},yₒ_{₁}) and (xₒ_{₂},yₒ_{₂}) (for example falling within regions 1 and 2 respectively in FIG. 4), where the offsets are particular distances in the image based on the predefined measurement pattern. The decoder operates by comparing the values between these relative offset locations (i.e. (x−xₒ_{₁},x−yₒ_{₁}) vs (x−xₒ_{₂},x−yₒ_{₂})), but considering only the signed differences between them across the respective three channels. Computing the signed differences provides a mechanism for storing digital information robustly, generally invariant to illumination changes in the scene, camera electronics and suboptimal camera colour calibration. A comparison yields one of three outcomes (per channel), namely a positive, negative, and no-change, defined by the deviation from a sensitivity threshold (denoted t_{L*}, t_{a*}, and t_{b*} for the three channels respectively). The three possible outcomes are mapped into a ternary (base-3) numbering system, corresponding to a value of “1” for positive results, “0” for no-change results, and “2” for negative results (i.e. 2, 1, 0). Each variational comparison (i.e. a comparison between two segments of the pattern) thus results in three signed outcomes for each of the three channels (so there are 27 possible outcomes altogether), defined as F_{δ}_{_{L*}}(x−xₒ_{₁}, y−yₒ_{₁}, x−xₒ_{₂}, y−yₒ_{₂}), F_{δ}_{_{a*}}(x−xₒ_{₁}, y−yₒ_{₁}, x−xₒ_{₂}, y−yₒ_{₂}), and F_{δ}_{_{b*}}(x−xₒ_{₁}, y−yₒ_{₁}, x−xₒ_{₂}, y−yₒ_{₂}) for the L*, a* and b* channels respectively, calculated as in Equation 1 for the L channel, and similarly for the a* and b* channels.

$${F}_{{δ}_{L}} , ( x - {x}_{{o}_{1}} , y - {y}_{{o}_{1}} , x - {x}_{{o}_{2}} , y - {y}_{{o}_{2}} ) = \{ \begin{matrix}2 & if ( {I}_{L *} ( x - {x}_{{o}_{1}} , y - {y}_{{o}_{1}} ) - {I}_{L *} ( x - {x}_{{o}_{2}} , y - {y}_{{o}_{2}} ) ) < - {t}_{L *} \\ 1 & if ( {I}_{L *} ( x - {x}_{{o}_{1}} , y - {y}_{{o}_{1}} ) - {I}_{L *} ( x - {x}_{{o}_{2}} , y - {y}_{{o}_{2}} ) ) > - {t}_{L *} \\ 0 & otherwise\end{matrix} \qquad ( 1 )$$

In the next step, the comparisons across all three channels are combined together to form a single variational “code” in which the three ternary numbers are grouped together into a single base-27 number (3 ternary numbers result in 3³=27 combinations). This code is denoted L_{i,j}, i≠j between the locations defined at offsets (xₒ_{ᵢ},yₒ_{ᵢ}) vs (xₒ_{ⱼ},yₒ_{ⱼ}), computed as follows:

L_{i,j}=F_{δ}_{_{L*}}(x−xₒ_{ᵢ},y−yₒ_{ᵢ},x−xₒ_{ⱼ},y−yₒ_{ⱼ})3²

+F_{δ}_{_{a*}}(x−xₒ_{ᵢ},y−yₒ_{ᵢ},x−xₒ_{ⱼ},y−yₒ_{ⱼ})3¹

+F_{δ}_{_{b*}}(x−xₒ_{ᵢ},y−yₒ_{ᵢ},x−xₒ_{ⱼ},y−yₒ_{ⱼ})3⁰ (2)

The method involves utilising a series of these variational comparisons computed progressively at offsets relative to a reference pixel. Each comparison results in a separate base-27 “digit”, and thus by combining a number N of variational comparisons, a sequence of these digits is formed that together form increasingly longer base-27 words. Consider a sequence of angular segments, where a particular region/segment is chosen as a reference, then progressing in a clockwise fashion, each pair of regions (denoted segments i and j respectively) generates a new digit that is appended to the least significant digit. Two preferred embodiments use 5 and 8 angular segments respectively (see FIGS. 3A and 3C for examples of 8-segment and 5-segment designs respectively), resulting in data strings in the form of the following 5-digit and 8-digit base-27 words respectively:

[L_{1,2},L_{2,3},L_{3,4},L_{4,5},L_{5,1}] (3)

[L_{1,2},L_{2,3},L_{3,4},L_{4,5},L_{5,6},L_{6,7},L_{7,8},L_{8,1}] (4)

Theoretically the number of combinations that can be achieved from an length-k word is 27^{k}, and thus for the preferred 5- and 8-digit embodiments, a total of approximately 1.435×10⁷ and 2.824×10¹¹ combinations are possible. Further, it will be appreciated that comparisons need not be between neigbouring segments. For example, segment 1 could be compared with segment 3. Further where the code is a barcode one set of offsets could be used for detection of the visual object and a second set of offsets could be used to decode the visual object.

It will be appreciated that the above method allows multitudes of unique visual objects to be generated, encoded as a digital signature, and can thus operate both as a long-range detection and bar-coding system.

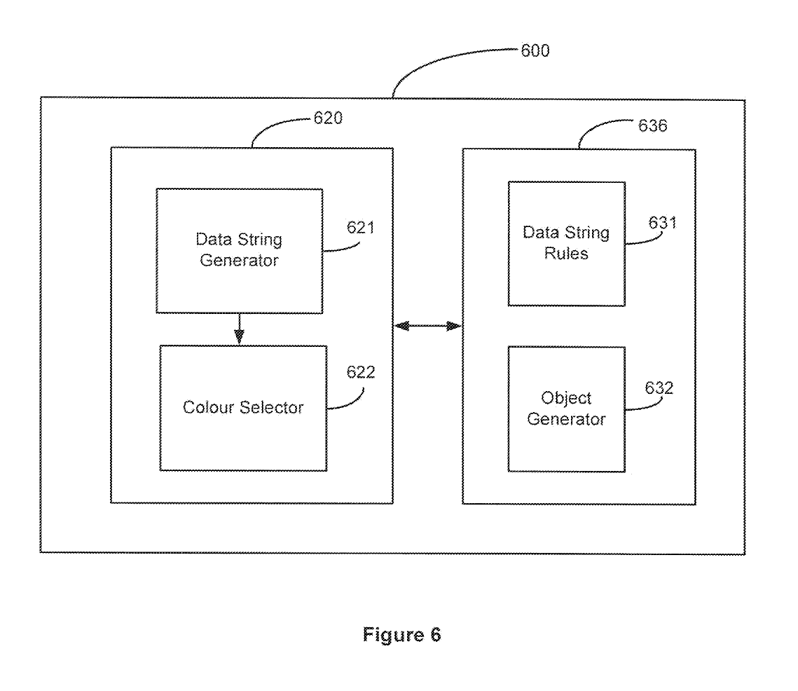

Accordingly, it will be appreciated that the invention extends a system 600 for forming a visual object. An example of such a system 600 is shown in FIG. 6 which shows a processor 620 implementing a data string generator 621 for generating a data string for example, at random or by obtaining the data string from a database. If the data string is generated at random, this can be based on data string rules 631 in memory 636 specifying the type of code to be generated. Such data string rules 631 may be user configurable.

The memory 630 also includes details of the object to be populated such that colour selector 622 can determine a set of colours that have colour values which when extracted in L*a*b* for example, will encode the data string.

The system 600 enables a method 800 of generating a visual object. The method involves obtaining a data string 810 and determining the type of visual object to be generated. This may involve determining how many segments are required to encode the data string or using a predefined type of visual object—e.g. an eight-segment object. The method then involves obtaining a set of spatial relationships 830 that are to be used to detect and/or decode the data string. The set of offsets can be predefined or can be chosen in conjunction with colours for each segment. The method then involves selecting 830 colours for each segment of the visual object such that differences in colour values derived based on the spatial relationships encode the data string.

As indicated above, there may be a number of applications of the invention. For example, while the visual objects of the embodiment are intended to be used in long distance detection, it is possible that they could also be used as an alternative form of barcode.

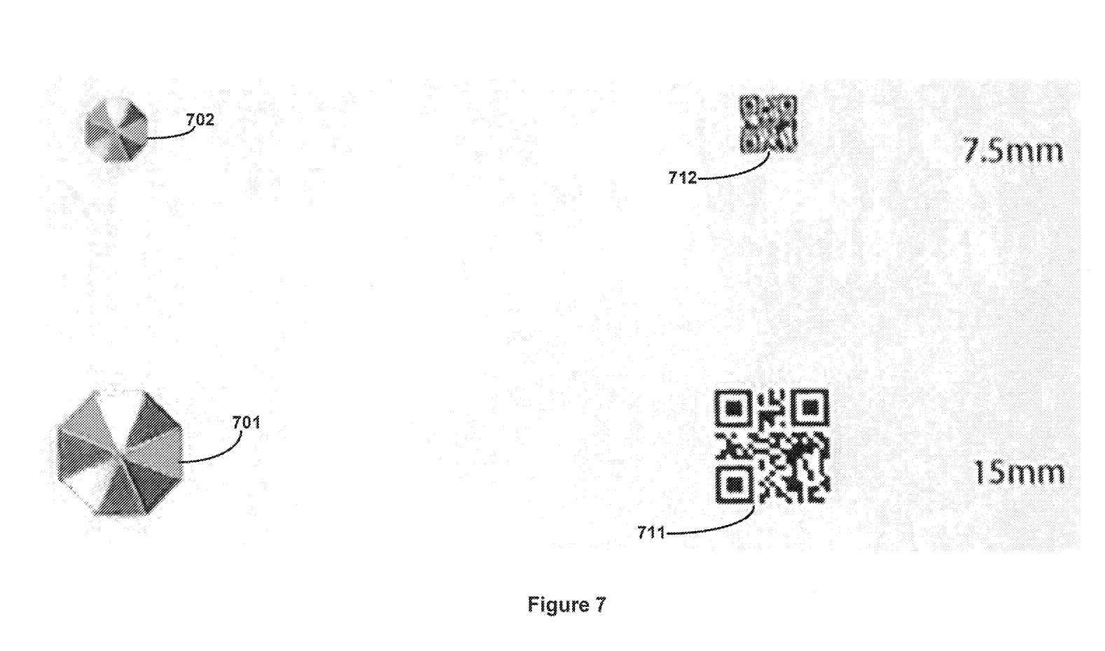

As indicated above, a benefit of the invention is that it is less susceptible to motion-blur. This is because the method does not make use of either gradient or edge information in an image to perform the detection and decoding. Instead, it utilises intensity/colour-differentials between relative offsets from a reference point to generate a code or signature. Methods such as traditional 1-dimensional barcodes or 2-dimensional barcodes (e.g. QR-codes, shot-codes or Data Matrix) rely on the separation of spatial regions based on intensity changes between two high-contrasting regions, achieved by detecting edges or grey-level thresholding. Such methods are fundamentally limited by the requirement to achieve in-focus images, since blurring of the image smears/corrupts the essential gradient information required for decoding. Invariance to a degree of blurring is important for applications involving imaging of tags attached to moving objects, or moving cameras, both of which result in significant motion blur. A related phenomenon occurs when imaging tags/barcodes at long ranges where camera optics may not be ideal (e.g. low-cost mobile-device camera optics). In these cases, poor optics result in sub-optimal representations of the target by the camera (due to the inability of the lenses to focus light), and “smearing” occurs. This effect manifests itself in a similar way to the aforementioned blurring, and thus the application of the proposed method to these scenarios is very advantageous. FIG. 7 demonstrates this effect via an experiment. In this experiment, a low quality camera with an 8 megapixel resolution is imaging a printed sheet at a distance of 600 mm. Tags 701,702 in accordance with the embodiments and QR-codes 711,712 are printed at first and second size. Thus tag 701 and QR code 711 printed at a first size and tag 702 and QR code are printed at a second size, half the width of the first size. As size decreases, the effect of the poor-quality optics is striking for the QR-code 712, with a complete corruption of image data relative to QR-code 711. On the other hand, as the tag 702 relies simply on the spatial arrangement of coloured regions, they remain robust for far smaller sizes, or equivalently, much longer ranges. It will also be appreciated that the QR-code 711,712 requires a white space around it for detection whereas the tag 701,702 does not. Further aspects of the method will be apparent from the above description of the system. It will be appreciated that at least part of the method will be implemented electronically, for example, digitally by a processor executing program code. In this respect, in the above description certain steps are described as being carried out by a processor, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention, in particular it will be apparent that certain features of embodiments of the invention can be employed to form further embodiments and that not all embodiments need to address all disadvantages of the prior art or provide all advantages of the present invention.

For example, the segments need not meet at the centre (or at all) in order to employ the detection technique of using offsets but in the above examples they touch to enable the tag to be made as small as possible,

In some embodiments, for example those where it is not necessary to locate the tag (e.g. if the tag is presented for decoding), the segments can be other predefined patterns. E.g 4 cubes arranged in 2×2 matrix or 6 triangles arranged in 2×3 matrix. Likewise it is possible to have multiple centres, e.g. a diamond flanked by 4 triangles.

The segments' measured characteristics may be tailored to non-Bayer arranged CCD arrays with different sensing elements (e.g., SuperCCD SR (Fuijifilm), multiband Infra-Red etc)

As indicated above, more thresholds can be used to define more unique numbers at a trade-off of reduced decoding certainty.

In one embodiment, restrictions are placed on the generation of tag combinations are used in order to achieve a particular property, e.g. achieving a significant change in either luminance or chrominance between every adjacent tag sector (as measured utilising the offset calculations). For example, while adjacent sectors can have the same intensity and colour representation, which in itself forms part of the overall code ensuring that there is a significant change in either luminance or chrominance between every adjacent tag sector sacrifices a subset of the available codes that can be used, but with two advantages for applications:

1. A successive set of adjacent differences in sectors creates tags that are increasingly artificial compared to objects and patterns present in typical applications, decreasing the probability of falsely detecting a background object as a tag.
2. A successive set of sector changes provides a computational constraint that can be utilised to implement a more efficient decoding algorithm. Instead of computing a code utilising all offsets, an “early-breakout” approach can be used in which the calculation for a particular pixel terminates as soon as a lack of variation is detected.

This method is particularly suited to applications, in which a scene is expected to comprise only a few or no tags at all, and thus early breakout is employed most of the time. For an 8-sector tag, this can reduce the number of required calculations by over 80%.

The technique described above applies to a tag pattern involving several spatial sectors arranged about a point. This provides a means to utilise a minimal spatial “footprint” to encode an identity value, with the added property of scale invariance. The principle of measuring variational characteristics utilising offsets relative to a particular point is can also be applied to other spatial pattern arrangements, in which differences in intensity and colour variations can be exploited using the same method.

In one embodiment, which may be termed “coded lines”, employs extended relationships between regions such as the border between spatial regions with different intensity and colour characteristics. Such a pattern variation can be exploited in a similar way to the method described above, with offsets relative to a particular point used to ascertain the spatial offsets achieving the maximum variation in intensity/colour, followed by a decoding of the variation in intensity/colour using the technique described above. That is, when a pair of offsets are to either side of the border, they will generate local maxima colour variation.

This provides a code, which can be used to label the reference pixel/position. In the same way, this technique can be used to label all pixels in a “label” image, forming a connected set of pixels along the interface between the two regions. An additional clustering step (achieved via a known algorithm such as clustering, edge detection or connected component analysis), allows for isolation of all pixels labelled with the same value, resulting in a coded line where each pixel along the line can take one of 27 different codes. One application of such a method is to provide a continuous coded reference in a scene where a camera only views a portion of the reference object.

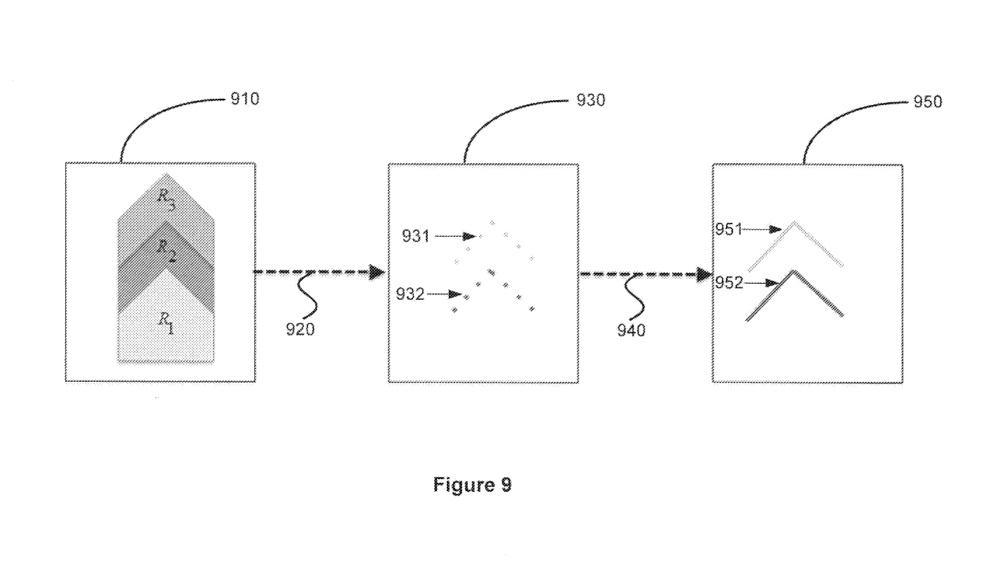

An example is shown in FIG. 9. The initial image 910 has three coloured regions labelled R₁, R₂ and R₃. Pixel decoding 920 is performed by an image sampler 214 moving a sampling template with relatively small offsets (e.g. 3 pixels) over image 910. When the sampling template is wholly within any one of the three regions, the difference in colour values in L*a*b* space will be zero. However, at the interface between the regions there will be differences in colour values and a number of coded pixels having the same value will be locate. Accordingly, in this embodiment, the detection determiner 217 can be arranged to find at least part of the visual object by finding a plurality of sampling positions that correspond to maximums in the differences between the colour values to produces the pixel decoded image 930. The pixel decoded image 930 shows two sets of decoded pixels 931,932. Spatial clustering 940 is then performed by the detection determiner 217 to find the two coded lines 951, 952 in the processed image 850. The lines 951,952 are shown in different shades in image 850 to indicate that they encode different base-27 values.

A larger set of codes can be achieved by creating several parallel lines adjacent to each other, creating multiple coded lines, which could then be combined by spatial grouping.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electronic method of detecting a visual object in an image of a scene, the method comprising:
sampling the image at sampling points with a sampling template defining a fixed set of image detection offsets relative to any sampling point at which the image is sampled, each of the set of image detection offsets being related to another one of the image detection offsets;
obtaining at least one colour value for each image detection offset relative to any sampling point;
forming a set of data values by, for each image detection offset, comparing each at least one colour value with a corresponding colour value of the related image detection offset to obtain a data value; and
upon a set of data values obtained for a sample point satisfying a detection condition for the visual object, determining that the visual object has been located.

2. A method as claimed in claim 1 wherein the image detection offsets are spaced relative to one another in order to be able to detect an object comprising a known number of angular segments, each segment comprising a pair of radially extending sides that extend to a common radial extent relative to a common central point.

3. A method as claimed in claim 1 or claim 2, comprising converting the image to a colour space from which the colour values are to be obtained before sampling the image.

4. A method as claimed in claim 3, wherein the colour space is L*a*b* space.

5. A method claimed in claim 3 or claim 4, comprising converting sampled portions of the image to a colour space before comparing colour values.

6. A method as claimed in any one of claims 1 to 5, comprising comparing three colour values for each image detection offset.

7. A method as claimed in any one of claims 1 to 6, wherein there is a set of possible data values that can be determined from each comparison.

8. A method as claimed in claim 7, wherein there are three possible data values that can be determined from each comparison.

9. A method as claimed in any one of claims 1 to 8, wherein comparing each colour value comprises calculating a difference between the one colour value and the corresponding colour value of the related image.

10. A method as claimed in claim 9, comprising allocating a data value to the calculated difference by applying at least one threshold to the calculated difference.

11. An electronic method of extracting a data string from a visual object in an image of a scene, the method comprising:
sampling the image at a sampling point corresponding to the visual object with a sampling template defining a fixed set of image decoding offsets relative to any sampling point at which the image is sampled, each of the set of image decoding offsets being related to another one of the image decoding offsets;
obtaining at least one colour value for each image decoding offset relative to any sampling point;
obtaining a set of data values by, for each image decoding offset, comparing each at least one colour value with a corresponding colour value of the related image decoding offset to obtain a data value; and
forming a data string from the set of obtained data values.

12. A method as claimed in claim 11 wherein the image decoding offsets are spaced relative to one another in order to be able to decode an object comprising a known number of angular segments, each segment comprising a pair of radially extending sides that extend to a common radial extent relative to a common central point.

13. A method as claimed in claim 11 or claim 12, comprising determining the sample point by sampling the image at sampling points with a sampling template defining a fixed set of image detection offsets relative to any sampling point at which the image is sampled, each of the set of image detection offsets being related to another one of the image detection offsets;
obtaining at least one colour value for each image detection offset;
forming a set of data values by, for each image detection offset, comparing each at least one colour value with a corresponding colour value of the related image detection offset to obtain a data value; and
upon a set of data values, obtained for a sample point satisfying a detection condition determining that a sample point has been located for decoding the object.

14. A method as claimed in claim 13, wherein there is a single sampling template comprising both the image detection offsets and the image decoding offsets whereby a single sampling process is used to obtain data values for detection and decoding.

15. A system for detecting a visual object in an image of a scene, the system comprising:
an image sampler arranged to sample the image at sampling points with a sampling template defining a fixed set of image detection offsets relative to any sampling point at which the image is sampled, each of the set of image detection offsets being related to another one of the image detection offsets;
a data set extractor arranged to form a set of data values by, for each image detection offset, comparing at least one colour value obtained at the image detection offset with a corresponding colour value obtained at the related image detection offset to obtain a data value; and
a detection determiner arranged to determine that the visual object has been located upon a set of data values, obtained for a sample point satisfying a detection condition.

16. A system for extracting a data string from a visual object in an image of a scene, the system comprising:
an image sampler for sampling the image at a sampling point corresponding to the visual object with a sampling template defining a fixed set of image decoding offsets relative to any sampling point at which the image is sampled, each of the set of image decoding offsets being related to another one of the image decoding offsets;
an image decoder arranged to process at least one colour value for each image decoding offset to obtain a set of data values by, for each image decoding offset, comparing each at least one colour value with a corresponding colour value of the related image decoding offset to obtain a data value, and form a data string from the set of obtained data values.

17. A system as claimed in claim 16,
wherein the image sampler is arranged to sample the image at sampling points with a sampling template defining a fixed set of image detection offsets relative to any sampling point at which the image is sampled, each of the set of image detection offsets being related to another one of the image detection offsets,
wherein the image decoder forms a set of data values by, for each image detection offset, comparing each at least one colour value of the image detection offset with a corresponding colour value of the related image detection offset to obtain a data value, and
further comprising a sample point determiner arranged to determine a sample point has been located for decoding the object upon a set of data values satisfying a detection condition.

18. An electronic method of detecting a visual object in an image of a scene, the method comprising:
sampling the image at sampling points with a sampling template defining a fixed set of image detection offsets relative to any sampling point at which the image is sampled; and
determining the location of at least part of the visual object by finding a plurality of sampling positions that correspond to local maximums in the difference between colour values for the image detection offsets.

19. A method as claimed in claimed in claim 18, comprising determining a data value from the at least one colour value that corresponds to the local maximum in difference between colour values.

20. A method as claimed in claim 19, comprising locating all connected locations in the image having the same data value.

21. A method as claimed in any one of claims 18 to 20, comprising converting the image to a colour space from which the colour values are to be obtained before sampling the image.

22. A method as claimed in claim 21, wherein the colour space is L*a*b* space.

23. A system for detecting a visual object in an image of a scene, the system comprising:
an image sampler arranged to sample the image at sampling points with a sampling template defining a fixed set of image detection offsets relative to any sampling point at which the image is sampled; and
a detection determiner arranged to determine the location of at least part of the visual object by finding a plurality of sampling positions that correspond to local maximums in the difference between colour values for the image detection offsets.

24. An electronic method of forming a visual object that can be applied to an article to encode a data string, the method comprising:
obtaining a data string to be encoded;
forming an arrangement of a plurality of angular segments;
obtaining a set of spatial relationships to be used in determining the data string, the set of spatial relationships corresponding to the relative positions of at least some of the plurality of angular segments; and
selecting a set of colours for the plurality of angular segments based on the set of spatial relationships such that, for each spatial relationship, differences in colour values between positions defined by the respective spatial relationship encode a portion of the data string, whereby the entire data string can be assembled from the respective portions of the data string.

25. A method as claimed in claimed in claim 24, comprising selecting the colour of at least one segment based on a colour of at least one other segment.

26. A method as claimed in claimed in claim 25, comprising selecting the colour of at least one segment based on a background colour.

27. A method as claimed in any one of claims 24 to 26, wherein each offset defines a spatial relationship between a pair of the angular segments.

28. A method as claimed in any one of claims 24 to 27, wherein the set of spatial relationships have an associated evaluation order and the data string is assembled by concatenating the portions of the data string in the evaluation order.

29. A system for forming a visual object encoding a data string, the system comprising a processor arranged to process a data string to select a set of colours for respective one of a plurality of segments of a visual object based on a set of spatial relationships, each colour selected such that, for each spatial relationship, differences in colour values between positions defined by the respective spatial relationship encode a portion of the data string, whereby the entire data string can be assembled from the respective portions of the data string.

30. An article comprising a visual object that encodes a data string,
the object comprising a plurality of angular segments, each segment comprising a colour selected to encode a portion of the data string based on a set of spatial relationships such that, for each spatial relationship, differences in colour values obtained by image processing a part of an image of the object corresponding to the positions defined by the respective spatial relationship encode a portion of the data string, whereby the entire data string can be assembled from respective portions of the data string.

31. An article as claimed in claim 30, wherein each segment comprising a pair of radially extending sides that extend to a common radial extent relative to a common central point to thereby allow the object to be detected during image processing of images of different spatial scales that contain the object.

32. An article as claimed in claim 30 or claim 31, wherein for at least one segment, the other colour value is obtained from a related segment of the object.

33. An article as claimed in claim 32, wherein the related segment is related by being a neighbouring segment.

34. An article as claimed in any one of claims 30 to 33, wherein for at least one segment, the other colour value is obtained from a background colour.

35. An article as claimed in claim 34, wherein the background colour is a colour of the article where the object is positioned on the article.

36. An article as claimed in claim 35, wherein the background colour is a colour of the object at a position not having a segment.

37. An article as claimed in any one of claims 30 to 36, wherein the colour chosen for each segment enables a plurality of colour values to be compared for each segment to obtain a plurality of portions of the data string.

38. An article as claimed in any one of claims 30 to 37, wherein the object is embedded in the article.

39. An article as claimed in any one of claims 30 to 38, wherein the object is attached to the article.

40. Computer program code which when executed implements the method of any one of claims 1 to 14 or 18 to 22.

41. A tangible computer readable medium comprising the computer program code of claim 40.
